(19) United States
(12) Patent Application Publication
(10) Pub. No.: US 2003/0213504 A1
(43) Pub. Date: Nov. 20, 2003

(54) Method for rinsing micro-dispensing syringes

(76) Inventors: Renato Cerra, Bulleen (AU); Ernest Frederick Da Wes, East Melbourne (AU); Stefan Karl Lofhelm, Langwarrin (AU)

Correspondence Address: DORSEY & WHITNEY LLP, INTELLECTUAL PROPERTY DEPARTMENT, 4 EMBARCADERO CENTER, SUITE 3400, SAN FRANCISCO, CA, 94111, US

(21) Appl. No.: 10/378,159

(22) Filed: Feb. 28, 2003

Related U.S. Application Data
(60) Provisional application No. 60/360,682, filed on Mar. 1, 2002.

(51) Int. Cl. B08B 9/00

(52) U.S. Cl. 134/23; 134/32; 134/57 R; 134/166 R

(57) ABSTRACT

This invention relates to liquid dispensing and to a method of rinsing micro-dispensing syringes. In particular, the invention relates to a method of rinsing syringes of the plunger-in-needle type provided in an array.

### FIELD OF THE INVENTION

This invention relates to liquid dispensing and to a method of rinsing micro-dispensing syringes. In particular, the invention relates to a method of rinsing syringes of the plunger-in-needle type provided in an array.

### BACKGROUND OF THE INVENTION

In various fields of chemical and biological research, there is a need to place known volumes of liquids within wells to facilitate the performance of various procedures. One common procedure is the performance of assays where various chemicals or substances are introduced into the wells and any reactions are evaluated.

The wells which receive the liquids are usually formed in plates having an array of wells. The number of wells in a plate typically ranges from 96 up to 1536. Small volume syringes are used to precisely aspirate and dispense very small volumes of liquids into and from multi-well plates used in techniques such as combinatorial chemistry, high throughput screening and others. The multi-well plates and syringes typically form part of an automated dispensing system which is employed to dispense fluids into the wells of the plates simultaneously.

Many reasons, including the advent of more sensitive detection techniques, have allowed scientists to work with much smaller volumes. In the field of micro-dispensing, the typical volume of fluid delivered into a well is in the range of a few nanolitres to several microlitres. With the use of such small volumes, it is essential that the volume of fluid is not only accurately measured and dispensed, but that the syringes are not contaminated prior to use. Contamination most commonly occurs due to the syringes not being properly cleaned or rinsed between each use, so that carry-over of fluids can occur. Cleaning and rinsing procedures between each delivery, while essential, need to take as little time as possible in order to maintain an efficient process. There is therefore an increased demand for improved syringe cleaning techniques.

Several methods have been used for eliminating carry-over. The easiest method is to use repeated aspiration and dispensing of a wash solution with the syringe. Because of the number of rinsing cycles required, this process can be very time consuming. The process usually only results in a dilution of any previously dispensed solutions and therefore does not truly eliminate carry-over.

One of the most effective methods of eliminating carry-over has been the use of disposable plastic tips. Nevertheless, disposable tips are expensive and may also introduce other disadvantages such as the ability to dispense very low volumes and to use very high density dispensing arrays.

A further type of small volume syringe is the plunger-in-needle type. These syringes include a syringe body and a plunger which is moveable within the syringe body to aspirate liquids into the syringe body and to dispense liquids from the syringe body. The plunger extends completely to the tip of the needle. This positive displacement method is used to provide the best volumetric accuracy of the samples being delivered. While it is ore accurate than previous methods involving disposable tips, it also carries a higher risk of cross-contamination between consecutive samples unless the syringe is thoroughly washed each time.

An object of the invention is to provide a simple and effective cleaning process for either a single syringe or an array of syringes that at least in part alleviates the above disadvantages.

### SUMMARY OF THE INVENTION

In a first aspect, the invention provides a method for rinsing a syringe, the method including:

providing a syringe having a needle and a plunger, the needle being provided with an opening to receive rinse fluid;

providing a wash module adjacent the needle, the wash module including:

first and second sealing means coaxial with the needle and adapted to form a fluid-tight seal against the outside of the needle; and

a cavity formed in the wash module and disposed between the first and second sealing means, the cavity being adapted to receive rinse fluid from an external source;

sealing the needle to permit aspiration and dispensing of fluids by creating relative movement of the needle and the wash module such that the first sealing means seals the opening of the needle; and

rinsing the needle by creating relative movement of the needle and the wash module to expose the opening to the cavity, causing rinse fluid to pass through the cavity, and thereby through the opening and needle, in order to rinse the needle.

Preferably, the opening is a side hole formed in a side wall of the needle, with relative movement between the wash module and needle selectively exposing the side hole to the cavity of the wash module.

In one embodiment, the wash module is slidably mounted with respect to the fixed needle. In this embodiment, the wash module is moveable between a position where the first sealing means seals the side hole, and a position where the side hole is exposed to the cavity and the rinse fluid.

In a preferred embodiment, the wash module remains fixed and the needle is mounted for reciprocating movement with respect to the wash module. In this embodiment, the needle is moveable between a position where the side hole of the needle is sealed by the first sealing means, and a position where the side hole is exposed to the cavity and the rinse fluid.

In a second aspect, the invention provides a method for rinsing a syringe, the method including:

providing a syringe having a needle and a plunger, the needle being provided with an opening to receive rinse fluid;

providing a wash module adjacent the needle and plunger, the wash module including:

first sealing means coaxial with the plunger and adapted to form a fluid-tight seal against the outside of the plunger;

second sealing means coaxial with the needle and adapted to form a fluid-tight seal against the outside of the needle;

a cavity formed in the wash module and disposed between the first and second sealing means, the cavity being adapted to receive rinse fluid from an external source; and

third sealing means provided adjacent the opening of the needle and engageable by the plunger to selectively seal the opening of the needle;

sealing the needle to permit aspiration and dispensing of fluids by moving the plunger such that the plunger engages the third sealing means and seals the opening of the needle; and

rinsing the needle by moving the plunger such that the plunger disengages the third sealing means thereby exposing the opening to the cavity, causing rinse fluid to pass through the cavity, and thereby through the opening and needle, in order to rinse the needle.

In a third aspect, the invention provides a liquid dispensing system including:

a syringe having a plunger and a needle, the plunger being moveable within the needle to aspirate liquids into the needle and to dispense liquids from the needle;

a wash module adjacent the needle, the wash module including:

first and second sealing means coaxial with the needle and adapted to form a fluid-tight seal against the outside of the needle; and

a cavity formed in the wash module and disposed between the first and second sealing means, the cavity being adapted to receive rinse fluid from an external source;

wherein the needle is formed with an opening to receive rinse fluid; and

wherein the needle is sealed to permit aspiration and dispensing of fluids by relative movement of the needle and wash module such that the first sealing means seals the opening of the needle; and

the needle is rinsed by relative movement of the needle and the wash module to expose the opening to the cavity, causing rinse fluid to pass through the cavity, and thereby through the opening and needle.

Preferably, the opening is a side hole formed in a side wall of the needle, with relative movement between the wash module and needle selectively exposing the side hole to the cavity of the wash module.

In one embodiment, the wash module is slidably mounted with respect to the fixed needle. In this embodiment, the wash module is moveable between a position where the first sealing means seals the side hole, and a position where the side hole is exposed to the cavity and the rinse fluid.

In a preferred embodiment, the wash module remains fixed and the needle is mounted for reciprocating movement with respect to the wash module. In this embodiment, the needle is movable between a position where the side hole of the needle is sealed by the first sealing means, and a position where the side hole is exposed to the cavity and the rinse fluid.

In a fourth aspect, the invention provides a liquid dispensing system including:

a syringe having a needle, the needle including an opening to receive rinse fluid, the syringe further including a plunger, the plunger being moveable within the needle to aspirate liquids into the needle and to dispense liquids from the needle;

a wash module adjacent the needle and plunger, the wash module including:

first sealing means coaxial with the plunger and adapted to form a fluid-tight seal against the outside of the plunger;

second sealing means coaxial with the needle and adapted to form a fluid-tight seal against the outside of the needle;

a cavity formed in the wash module and disposed between the first and second sealing means, the cavity being adapted to receive rinse fluid from an external source; and

third sealing means provided adjacent the opening of the needle and engageable by the plunger to selectively seal the opening of the needle;

wherein the needle is sealed to permit aspiration and dispensing of fluids by moving the plunger, such that the plunger engages the third sealing means and seals the opening of the needle; and

the needle is rinsed by moving the plunger such that the plunger disengages from the third sealing means thereby exposing the opening to the cavity, causing rinse fluid to pass through the cavity, and thereby through the opening and needle.

Advantageously, the syringe forms part of a syringe array, and the wash module is configured to allow a plurality of syringes to be rinsed simultaneously. In this embodiment, the wash module includes first and second sealing means for each of the needles. The cavity is continuous across the plurality of needles such that rinsing fluid from the cavity enters and rinses each of the needles.

The first and second sealing means preferably seal the cavity.

Preferably, the wash module and syringe array form part of an automated dispensing system.

The plunger is preferably moveable within the needle to aspirate liquids into the needle and to dispense liquids from the needle Preferably, the plunger extends completely to the tip of the needle.

The invention further extends to wash modules as described in relation to both the first and third, and second and fourth, aspects of the invention above.

### BRIEF DESCRIPTION OF THE DRAWINGS

The invention will now be described, by way of example only, with reference to the accompanying drawings in which:

FIG. 1 is a cross-sectional side view of a portion of the syringe array showing part of the wash module in a sealed configuration in accordance with a first embodiment of the invention;

FIG. 2 is a cross-sectional side view of the wash module as shown in FIG. 1 in a rinsing configuration;

FIG. 3 is a cross-sectional side view of a portion of the syringe array showing part of the wash module in a sealed configuration in accordance with a second embodiment of the invention; and

FIG. 4 is a cross-sectional side view of the wash module as shown in FIG. 3 in a rinsing configuration.

### DESCRIPTION OF PREFERRED EMBODIMENTS

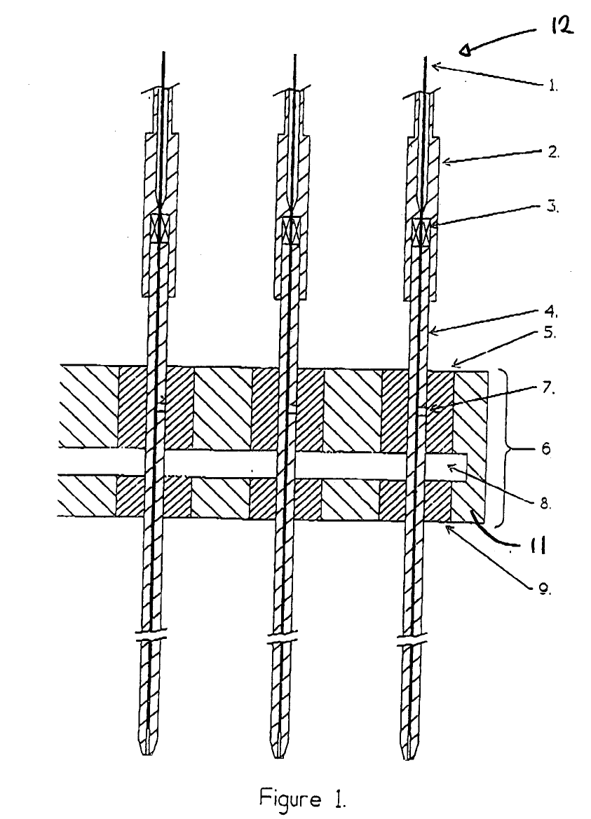

Referring to the figures, FIG. 1 illustrates part of an automated liquid delivery system in accordance with a first embodiment of the invention, showing a portion of a wash module 6 mounted with respect to a plurality of moveable syringes 12. It will be appreciated that the liquid delivery system may be designed such that the wash module 10 is moveable while the syringes remain fixed.

The liquid dispensing system is manufactured in a conventional manner and incorporates a syringe array. The syringe array is typically formed of a plurality of syringe array modules, such that the size of the array can be readily adjusted, with typically 96 to 1536 syringes in an array. The syringe array is used to aspirate and dispense fluids into the respective wells of a multi-well plate (not shown). The syringe array is used to aspirate samples of 10 μL or less, for example, from a first well plate, and then to distribute the samples in nanolitre volumes into a large number of further well plates where computer managed experiments and testing are performed. The syringe array is also used to administer reagents to the wells, aspirating from either a supply well plate or from a bath.

As shown in the figures, the syringes 12 of this embodiment of the invention utilize a plunger 1 which moves through a needle 4 to displace a volume of liquid that is substantially equal to the volume displaced by the plunger 1. Similarly, the syringes 12 aspirate liquids by retracting the plunger 1 to create a vacuum within each needle 4. Such a construction results in a zero dead volume within the needle 4 so that all of the liquid that is aspirated is dispensed. Further, the volume aspirated and dispensed may be varied by varying the length of the stroke of the plunger 1 and/or by varying the size of the plunger 1.

Each of the syringes 12 of the syringe array is secured at their upper end in a mount (not shown) in a conventional manner. The syringes are mounted for reciprocating movement in a vertical direction through a wash module 6, as described below. A holding system (not shown) may also be utilized to ensure the syringes 12 remain precisely laterally spaced apart and remain positioned within the same plane during aspiration and dispensing.

In accordance with this embodiment, each of the needles 4 is formed with a rinse hole 7 formed in the side wall of the needle 4. Rinse hole 7 permits rinse fluid to enter the needle from the wash module 6.

Wash module 6 is fixedly mounted with respect to the needles 4 such that each needle intersects the module 6. One or more wash modules 6 may be provided on a syringe array. Wash module 6 includes a body 11, an upper sealing means 5, and lower sealing means 9. The upper and lower sealing means 5, 9 surround and seal a manifold cavity 8 formed in the wash module 6. The upper and lower sealing means 5, 9 are coaxial with each of the respective needles 4 and provide a fluid-tight seal against the outer surface of each needle 4. Manifold cavity 8 is preferably provided with a port and hose (not shown) which connect the interior of the cavity 8 to an external source of rinsing fluid (not shown).

During normal aspirating and dispensing operation, the rinse holes 7 in the needles 4 are sealed by the cylindrical upper seals 5 as shown in FIG. 1.

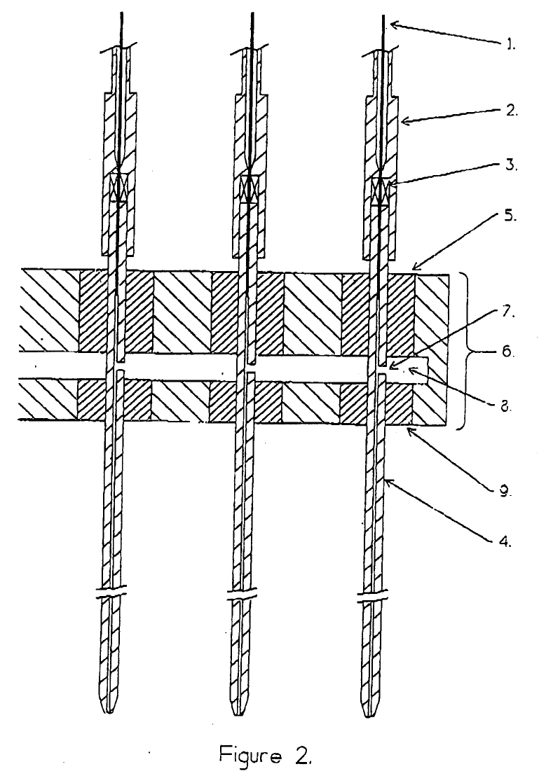

During the cleaning process, the plungers 1 are partially withdrawn from each needle 4 until they are above the side hole 7, as shown in FIG. 2. The needles 4 are positioned with respect to the wash module 6 such that the side holes 7 of the needles 4 are aligned with the manifold cavity 8. The cavity is sealed by the top seal 5 and bottom seal 9. A suitable rinse fluid is passed through the manifold cavity 8 and consequently through the inside of the needle 4 by means of the exposed side hole 7. This technique ensures an effective rinse solution can be passed through the inside of the needle 4 without withdrawing the plunger 1 from the top of the needle 4 and seal 3.

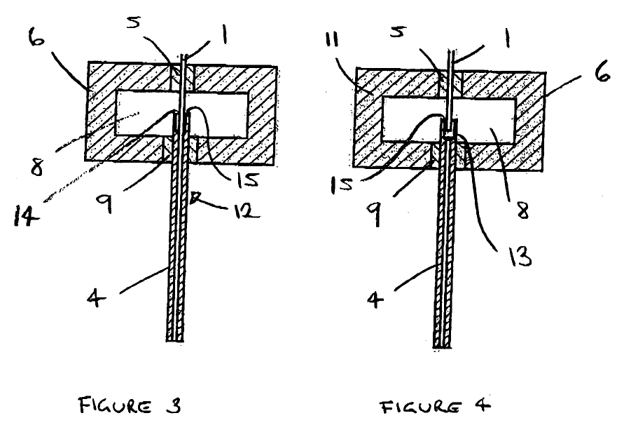

A second embodiment of the invention is shown in FIGS. 3 and 4. In this embodiment, like reference numerals are used to designate similar parts.

FIG. 3 illustrates part of an automated liquid delivery system with the needle 4 in a sealed configuration. The syringes 12 of this embodiment are also of the plunger-in-needle type.

In accordance with this embodiment, wash module 6 and needles 4 are fixedly mounted with respect to each other. One or more wash modules 6 may be provided on a syringe array. Wash module 6 includes a body 11, an upper sealing means 5 and lower sealing means 9. The upper and lower sealing means 5, 9 surround and seal a manifold cavity 8 formed in the wash module 6.

The upper end 13 of each needle 4 is received within cavity 8 and is surrounded by seal 9. Plunger 1 is received by the upper seal 5, intersects cavity 8, before being received by the bore of needle 4. Plunger 1 is slidingly received by seal 5 and needle 4.

The upper end 13 of needle 4 includes a further sealing means 15 which slidingly receives the plunger 1 as it enters the needle bore. When the plunger 1 is received within the seal 15, the seal 15 surrounds the plunger 1 and forms a fluid-tight seal, thereby sealing the opening 14 at the top of the needle bore. As the plunger is withdrawn from the seal 15, the needle bore is exposed to the cavity 8. Opening 14 permits rinse fluid to enter the needle from the wash module 6.

Manifold cavity 8 is preferably provided with a port and hose (not shown) which connect the interior of the cavity 8 to an external source of rinsing fluid (not shown).

During the cleaning process, the plunger 1 is withdrawn from each needle 4 until it is removed from seal 15, as shown in FIG. 4. The cavity remains sealed by the top seal 5 and bottom seal 9. A suitable rinse fluid is passed through the manifold cavity 8 and consequently through the inside of the needle 4 by means of the exposed needle bore.

In either of the above embodiments, after a sufficient rinse fluid has been passed through the needle 4, a suitable compressed gas may be passed through the manifold cavity 8 and needles 4 to remove any residual rinse fluid and to dry the needles 4. The needles 4, or the plunger 1, are then repositioned to seal the needles 4 and hence allow normal operation to continue.

Alternative cleaning sequences are possible depending on the application.

In an alternate embodiment, the bottom seal 9 is designed to leak at a controlled rate under certain pressure. With this variation, the fluid in the manifold cavity 8 will be passed through the needle 4, as described above, and also a controlled amount will pass through the bottom seal 9, so that the outside of the needles are also rinsed.

It will be appreciated that the method of rinsing needles in a syringe array as described above alleviates several of the disadvantages associated with prior art cleaning systems. Use of a needle-in-plunger type syringe offers the advantage that zero or minimal dead volume exists in the needle. Any residual fluid that remains in the needle is effectively and quickly rinsed by simple movement of the wash module with respect to the needle, or of the plunger with respect to the needle, so as to expose the interior of the needle to the rinse fluid.

It will be understood that the invention disclosed and defined in this specification extends to all alternative combinations of two or more of the individual features mentioned or evident from the text or drawings. All of these different combinations constitute various alternative aspects of the invention.

What is claimed is:

1. A method for rinsing a syringe comprising:
providing a syringe having a needle and a plunger, said needle being provided with an opening to receive rinse fluid;
providing a wash module adjacent said needle, said wash module comprising:
first and second sealing means coaxial with said needle and adapted to form a fluid-tight seal against the outside of said needle; and
a cavity formed in the wash module and disposed between the first and second sealing means, said cavity being adapted to receive rinse fluid from an external source;
sealing said needle to permit aspiration and dispensing of fluids by creating relative movement of said needle and said wash module such that said first sealing means seals the opening of said needle; and
rinsing said needle by creating relative movement of said needle and said wash module to expose the opening to said cavity, whereby rinse fluid passes through said cavity, and through said opening of said needle to rinse said needle.

2. The method of claim 1 wherein said opening is a side hole formed in a side wall of said needle, with relative movement between said wash module and said needle selectively exposing the side hole to said cavity of said wash module.

3. The method of claim 2 wherein said needle is fixed and said wash module is slidably mounted with respect to said fixed needle, whereby said wash module is moveable between a first position where said first sealing means seals said side hole, and a second position where said side hole is exposed to said cavity and the rinse fluid.

4. The method of claim 2 wherein said wash module remains fixed and said needle is mounted for reciprocating movement with respect to said wash module, whereby said needle is moveable between a first position where said side hole of said needle is sealed by said first sealing means, and a second position where said side hole is exposed to the cavity and the rinse fluid.

5. A method for rinsing a syringe comprising:
providing a syringe having a needle and a plunger, said needle being provided with an opening to receive rinse fluid;
providing a wash module adjacent said needle and said plunger, said wash module including:
first sealing means coaxial with said plunger and adapted to form a fluid-tight seal against the outside of said plunger;
second sealing means coaxial with said needle and adapted to form a fluid-tight seal against the outside of said needle;
a cavity formed in said wash module and disposed between said first and said second sealing means, said cavity being adapted to receive rinse fluid from an external source; and
third sealing means provided adjacent the opening of said needle and engageable by said plunger to selectively seal the opening of said needle;
sealing said needle to permit aspiration and dispensing of fluids by moving said plunger such that said plunger engages said third sealing means and seals the opening of said needle; and
rinsing said needle by moving said plunger such that said plunger disengages said third sealing means thereby exposing the opening to said cavity, whereby rinse fluid passes through said cavity through said opening and said needle to rinse said needle.

6. A liquid dispensing system comprising:
a syringe having a plunger and a needle, said plunger being moveable within said needle to aspirate liquids into said needle and to dispense liquids from said needle;
a wash module adjacent the needle, the wash module comprising:
first and second sealing means coaxial with said needle and adapted to form a fluid-tight seal against the outside of the needle; and
a cavity formed in the wash module and disposed between said first and second sealing means, said cavity being adapted to receive rinse fluid from an external source;
wherein said needle is formed with an opening to receive rinse fluid; and
wherein said needle is sealed to permit aspiration and dispensing of fluids by relative movement of said needle and said wash module such that said first sealing means seals the opening of said needle;
whereby said needle is rinsed by relative movement of said needle and said wash module to expose the opening to said cavity, causing rinse fluid to pass through said cavity, and thereby through said opening of said needle.

7. The system of claim 6 wherein said opening is a side hole formed in a side wall of said needle, whereby relative movement between said wash module and said needle selectively exposes the side hole to said cavity of said wash module.

8. The system of claim 7 wherein said needle is fixed on said wash module is and slidably mounted with respect to said fixed needle, wherein the wash module is moveable between a first position where said first sealing means seals said side hole, and a second position where said side hole is exposed to said cavity and said rinse fluid.

9. The system of claim 7 wherein said wash module remains fixed and said needle is mounted for reciprocating movement with respect to said wash module, wherein said needle is movable between a first position where said side hole of said needle is sealed by said first sealing means, and a second position where said side hole is exposed to said cavity and said rinse fluid.

10. A liquid dispensing system comprising:
a syringe having a needle, said needle comprising an opening to receive rinse fluid, said syringe further comprising a plunger, said plunger being moveable within said needle to aspirate liquids into said needle and to dispense liquids from said needle;
a wash module adjacent said needle and said plunger, the wash module including:
first sealing means coaxial with said plunger and adapted to form a fluid-tight seal against the outside of said plunger;
second sealing means coaxial with the needle and adapted to form a fluid-tight seal against the outside of said needle;
a cavity formed in said wash module and disposed between said first and said second sealing means, said cavity being adapted to receive rinse fluid from an external source; and
third sealing means adjacent to said opening of said needle and engageable by said plunger to selectively seal the opening of said needle;
wherein said needle is sealed to permit aspiration and dispensing of fluids by moving said plunger to engage said third sealing means to seal the opening of said needle; and
wherein said needle is rinsed by moving said plunger such that said plunger disengages from said third sealing means thereby exposing said opening to said cavity, thereby causing rinse fluid to pass through said cavity, and through said opening and said needle.

11. The system of claim 11 wherein said syringe forms part of a syringe array, and said wash module is configured to allow a plurality of syringes to be rinsed simultaneously, wherein said wash module comprises first and second sealing means for each of said needles and said cavity is continuous across said plurality of needles such that rinsing fluid from said cavity enters and rinses each of said needles.

12. The system of claim 11 wherein said first and second sealing means seal said cavity and said wash module and said syringe array form part of an automated dispensing system.
